(19) United States
(12) Patent Application Publication
(10) Pub. No.: US 2008/0249762 A1
(43) Pub. Date: Oct. 9, 2008

(54) CATEGORIZATION OF DOCUMENTS USING PART-OF-SPEECH SMOOTHING

(75) Inventors: Jian Wang, Beijing (CN); Jian-Tao Sun, Beijing (CN); Shen Huang, Beijing (CN); Zheng Chen, Beijing (CN)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 11/697,112

(22) Filed: Apr. 5, 2007

(51) Int. Cl. G06F 17/20

(52) U.S. Cl. 704/9; 704/E15.001

(57) ABSTRACT

A method and system is provided for classifying documents based on the subjectivity of the content of the documents using a part-of-speech analysis to help account for unseen words. A classification system trains a classifier using the parts of speech of training documents so that the classifier can classify unseen words based on the part of speech of the unseen word. The classification system then trains a part-of-speech model using the parts of speech of the n-grams of training data and labels of the training documents, and trains a term model using the term unigrams and labels. To classify a target document, the classification system applies the part-of-speech model to the part-of-speech n-grams of the target document and the term model to term n-grams of the target document.

### BACKGROUND

The World Wide Web (“web”) provides access to an enormous collection of information that is available via the Internet. The Internet is a worldwide collection of thousands of networks that span over a hundred countries and connect millions of computers. As the number of users of the web continues to grow, the web has become an important means of communication, collaboration, commerce, entertainment, and so on. The web pages accessible via the web cover a wide range of topics including politics, sports, hobbies, sciences, technology, current events, and so on. The web provides many different mechanisms through which users can post, access, and exchange information on various topics. These mechanisms include newsgroups, bulletin boards, web forums, web logs (“blogs”), new service postings, discussion threads, product review postings, and so on.

Because the web provides access to enormous amounts of information, it is being used extensively by users to locate information of interest. Because of this enormous quantity, almost any type of information is electronically accessible; however, this also means that locating information of interest can be very difficult. Many search engine services, such as Google and Yahoo, provide for searching for information that is accessible via the Internet. These search engine services allow a user to search for web pages that may be of interest. After a user submits a search request (also referred to as a “query”) that includes search terms, the search engine service identifies web pages that may be related to those search terms. The search engine service then displays to the user links to those web pages that may be ordered based on their relevance to the search request and/or their importance.

Various types of experts, such as political advisors, social psychologists, marketing directors, pollsters, and so on, may be interested in analyzing information available via the Internet to identify views, opinions, moods, attitudes, and so on that are being expressed. For example, a company may want to mine web logs and discussion threads to determine the views of consumers of the company's products. If a company can accurately determine consumer views, the company may be able to respond more effectively to consumer demand. As another example, a political adviser may want to analyze public response to a proposal of a politician so that the adviser may advise his clients how to respond to the proposal based in part on this public response.

Such experts may want to concentrate their analyses on subjective content (e.g., opinions or views), rather than objective content (e.g., facts). Typical search engine services, however, do not classify search results as being subjective or objective. As a result, it can be difficult for an expert to identify subjective content from the search results.

Some attempts have been made to categorize documents as subjective or objective, referred to subjectivity categorization. These attempts, however, have not effectively addressed the “unseen word” problem. An unseen word is a word within a document being categorized that was not in training data used to train the categorizer. If the categorizer encounters an unseen word, the categorizer will not know whether the word relates to subjective content, objective content, or neutral content. Unseen words are especially problematic in web logs. Because web logs are generally far less focused and less topically organized than other sources of content, they include words drawn from a wide variety of topics that may be used infrequently in the web logs. As a result, categorizers trained based on a small fraction of the web logs will likely have many unseen words. As a result, the categorizers often cannot effectively categorize documents (e.g., entries, paragraphs, or sentences) of web logs with unseen words.

### SUMMARY

A method and system is provided for classifying documents based on the subjectivity of the content of the documents using a part-of-speech analysis to help account for unseen words. A classification system trains a classifier using the parts of speech of training documents so that the classifier can classify an unseen word based on the part of speech of the unseen word. The classification system identifies n-grams of the parts of speech of the words of each training document. The classification system also identifies n-grams of the terms of the training documents. The classification system then trains a part-of-speech model using the parts of speech of the n-grams and labels of the training documents, and trains a term model using the term unigrams and labels. The models are trained by calculating probabilities of the n-grams being subjective. To classify a target document, the classification system applies the part-of-speech model to the part-of-speech n-grams of the target document and the term model to term n-grams of the target document. A model combines the probabilities of the n-grams to give a probability for that model. The classification system combines the probabilities of the models and designates the target document as being subjective or not based on the combined probabilities.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram that illustrates components of a classification system in one embodiment.

FIG. 2 is a block diagram that illustrates a logical data structure of a classifier store in one embodiment.

FIG. 3 is a flow diagram that illustrates the processing of the generate classifier component of the classification system in one embodiment.

FIG. 4 is a flow diagram that illustrates the processing of the train models component of the classification system in one embodiment.

FIG. 5 is a flow diagram that illustrates the processing of the generate n-grams component of the classification system in one embodiment.

FIG. 6 is a flow diagram that illustrates the processing of the learn model weights component of the classification system in one embodiment.

FIG. 7 is a flow diagram that illustrates the processing of the classify documents based on model component of the classification system in one embodiment.

FIG. 8 is a flow diagram that illustrates the processing of the classify document component of the classification system in one embodiment.

FIG. 9 is a flow diagram that illustrates the processing of the get classification probability component of the classification system in one embodiment.

FIG. 10 is a flow diagram that illustrates the processing of the calculate model weights component of the classification system in one embodiment.

### DETAILED DESCRIPTION

A method and system is provided for classifying documents based on the subjectivity of the content of the documents using a part-of-speech analysis to help account for unseen words. In some embodiments, a classification system trains a classifier using the parts of speech of training documents so that the classifier can classify unseen words based on the part of speech of the unseen word. The classification initially collects the training documents and labels the training documents based on the subjectivity of their content. For example, the classification system may crawl various web logs and treat each sentence or paragraph of a web log as a training document. The classification system may have a person manually label each training document as being subjective or objective. The classification system then identifies the parts of speech of the words or terms of the training documents. For example, the classification system may have a training document with the content “the script is a tired one.” The classification system, disregarding noise words, may identify the parts of speech as noun for “script,” verb for “is,” adjective for “tired,” and noun for “one.” The classification system then identifies n-grams of the parts of speech of each training document. For example, when the n-grams are bigrams, the classification system may identify the n-grams of “noun-verb,” “verb-adjective,” and “adjective-noun.” The classification system also identifies n-grams of the terms of the training documents. For example, when the n-grams are unigrams, the classification system may identify the n-grams of “script,” “is,” “tired,” and “one.” The classification system then trains a part-of-speech model using the parts of speech of the n-grams and labels, and trains a term model using the term unigrams and labels. The models may be for Bayesian classifiers. The models are trained by calculating probabilities of the n-grams being subjective. To classify a target document, the classification system applies the part-of-speech model to the part-of-speech n-grams of the target document and the term model to term n-grams of the target document. A model combines the probabilities of the n-grams to give a probability for that model. The classification system combines the probabilities of the models and designates the target document as being subjective or not based on the combined probabilities. Because the classification system uses the part-of-speech model, a document with an unseen word will be classified based at least in part on the part of speech of an unseen word. In this way, the classification system will be able to provide more effective classifications than classifiers that do not factor in unseen words.

In some embodiments, the classification system may use several different models for term n-grams and part-of-speech n-grams for n-grams of varying lengths (e.g., unigrams, bigrams, and trigrams). To generate a combined score for the models, the classification system learns weights for the various models. To learn the weights, the classification system may collect additional training documents and label those training documents. The classification system then uses each model to classify the additional training documents. The classification system may use a linear regression technique to calculate weights for each of the models to minimize the error between a classification generated by the weighted models and the labels. The classification system may iteratively calculate new weights and classify the training document until the error reaches an acceptable level or changes by less than a threshold amount from one iteration to the next.

The classification system uses a naïve Bayes classification technique. The goal of naïve Bayes classification is to classify a document d by the conditional probability P(c|d). Bayes' rule is represented by the following:

$$P ( c \text{\textbar} d ) = \frac{P ( c ) \times P ( d \text{\textbar} c )}{P ( d )} \qquad ( 1 )$$

where c denotes a classification (e.g., subjective or objective) and d denotes a document. The probability P(c) is the prior probability of category c. A naïve Bayes classifier can be constructed by seeking the optimal category which maximizes the posterior conditional probability P(c|d) as represented by the following:

c*=arg max{P(c|d)} (2)

Basic naive Bayes (“BNB”) introduces an additional assumption that all the features (e.g., n-grams) are independent given the classification label. Since the probability of a document P(d) is a constant for every classification c, the maximum of the posterior conditional probability can be represented by the following:

$${c}^{*} ∝ \text{arg} {max}_{c ∈ C} \{ P ( c ) \times {\prod }_{i = 1}^{N} P ( {w}_{i} \text{\textbar} c ) \} \qquad ( 3 )$$

where document d is represented by a vector of N features that are treated as terms appearing in the document, d=(w₁, w₂, . . . , wₙ).

In some embodiments, the classification system uses a naïve Bayes classifier based on term n-grams and part-of-speech n-grams. The classification system uses n-grams and Markov n-grams. An n-gram takes a sequence of n consecutive terms (which may be alphabetically ordered) as a single unit. A Markov n-gram considers the local Markov chain dependence in the observed terms. The classification system may use 10 different types of models and combine the models into an overall model. Each model uses a variant of basic naïve Bayes using term and part-of-speech models to calculate P(wᵢ|c).

The classification system may use a BNB model based on term unigrams where P_{BNB} (wᵢ|c) represents the probability for the BNB model.

The classification system may also use a naïve Bayes model based on part-of-speech n-grams (a “PNB” model). The PNB model uses part-of-speech information in subjectivity categorization. The probability of a part of speech is used for smoothing of the unseen word probabilities. The probability for the PNB model is represented by the following:

P_{PNB}(wᵢ|c)=P(posᵢ|c) (4)

where P_{PNB} represents the probability for the PNB model and posᵢ represents the part of speech of wᵢ.

The classification system may also use a naïve Bayes model based on term n-grams, where n is greater than 1 (“an NG model”). The probability of a term trigram (“TG”) model is represented by the following:

P_{TG}(wᵢ|c)=P(wᵢ₋₂wᵢ₋₁wᵢ|c) (i>3) (5)

where P_{TG} represents the probability of the TG model.

The classification system may also use a naïve Bayes model based on a part-of-speech n-gram, where n is greater than 1 (“a PNG model”). The PNG model helps solve the sparseness of n-grams and makes n-gram classification more effective. N-gram sparseness means that the n-gram with n greater than 1 has a very low probability of occurrence compared to a unigram. The probability of a part-of-speech trigram (“PTG”) model is represented by the following:

P_{PTG}(wᵢ|c)=P(posᵢ₋₂posᵢ₋₁posᵢ|c) (i>3) (6)

where P_{PTG} represents the probability of the PTG model.

The classification system may also use a naïve Bayes model using a Markov term n-gram (“an MNG model”). The model relaxes some of the independence assumptions of naïve Bayes and allows a local Markov chain dependence in the observed variables. The probability of a Markov term trigram (“MTG”) model is represented by the following:

P_{MTG}(wᵢ|c)=P(wᵢ|wᵢ₋₂wᵢ₋₁c) (i>3) (7)

where P_{MTG} represents the probability of the MTG model.

The classification system may also use a naïve Bayes model based on a Markov part-of-speech n-gram (“an MPNG model”). The MPNG model combines the concept of a Markov n-gram with parts of speech. The probability of a Markov part-of-speech trigram (“MPTG”) model is represented by the following:

P_{MPTG}(wᵢ|c)=P(posᵢ|posᵢ₋₂posᵢ₋₁c) (i>3) (8)

where P_{MPTG} represents the probability of the MPTG model.

The classification system may also use models based on bigrams that are analogous to those described above for the trigrams. Thus, the classification system may use a term bigram (“BG”) model, a Markov term bigram (“MBG”) model, a part of speech bigram (“PBG”) model, and a Markov part-of-speech bigram (“MPBG”) model. One skilled in the art will appreciate that the classification system may use n-grams of any length and may not use n-grams of one length, but may use n-grams of a longer length. Also, the models based on terms and parts of speech need not use n-grams of the same length.

The classification system may use smoothing techniques to overcome the problem of underestimated probability of any word unseen in a document. In general, smoothing techniques try to discount the probabilities of the words seen in the text and then assign an extra probability mass to the unseen words. A standard naïve Bayes model uses a Laplace smoothing technique. Laplace smoothing is represented by the following:

$$P ( w \text{\textbar} c ) = \frac{{N}_{j}^{c} + 1}{{N}^{c} + \vert V \vert} \qquad ( 9 )$$

where Nⱼ^{c} represents the frequency of word j appearing in category c, N^{c} represents the sum of the frequencies of the words appearing in category c, and |V| is the vocabulary size of the training data.

The classification system may also employ smoothing for unseen words in subjectivity classification using parts of speech. The classification system uses a linear interpolation of a term model and a part-of-speech model. The classification smooths based on the PNB model as represented by the following:

$$\begin{matrix}{P}_{SP} ( {w}_{i} \text{\textbar} c ) = α {P}_{BNB} ( {w}_{i} \text{\textbar} c ) + β {P}_{PNB} ( {w}_{i} \text{\textbar} c ) \\ = α P ( {w}_{i} \text{\textbar} c ) + β P ( {pos}_{i} \text{\textbar} c )\end{matrix} \qquad ( 10 )$$

The classification system also smooths based on the PNG model as represented by the following:

$$\begin{matrix}{P}_{TGSP} ( {w}_{i} \text{\textbar} c ) = α {P}_{TG} ( {w}_{i} \text{\textbar} c ) + β {P}_{PTG} ( {w}_{i} \text{\textbar} c ) \\ = α P ( {w}_{i - 2} {w}_{i - 1} {w}_{i} \text{\textbar} c ) + β P ( {pos}_{i - 2} {pos}_{i - 1} {pos}_{i} \text{\textbar} c )\end{matrix} \\ ( i > 3 ) \qquad ( 11 )$$

The classification system also smooths based on the MPNG model as represented by the following:

$$\begin{matrix}{P}_{MTGSP} ( {w}_{i} \text{\textbar} c ) = α {P}_{MTG} ( {w}_{i} \text{\textbar} c ) + β {P}_{MPTG} ( {w}_{i} \text{\textbar} c ) \\ = α P ( {w}_{i} \text{\textbar} {w}_{i - 2} {w}_{i - 1} c ) + β P ( {pos}_{i} \text{\textbar} {pos}_{i - 2} {pos}_{i - 1} c )\end{matrix} \\ ( i > 3 ) \qquad ( 12 )$$

where linear interpretation coefficients or weights α and β represent the contribution of each model.

The classification system may represent the overall combination of the models into a combined model by the following:

$$\begin{matrix}P ( {w}_{i} \text{\textbar} c ) = {α}_{1} {P}_{SP} ( {w}_{i} \text{\textbar} c ) + {α}_{2} {P}_{BGSP} ( {w}_{i} \text{\textbar} c ) + \\ {α}_{3} {P}_{TGSP} ( {w}_{i} \text{\textbar} c ) + {α}_{4} {P}_{MBGSP} ( {w}_{i} \text{\textbar} c ) + {α}_{5} {P}_{MTGSP} ( {w}_{i} \text{\textbar} c ) \\ = {β}_{1} {P}_{BNB} ( {w}_{i} \text{\textbar} c ) + {β}_{2} {P}_{PNB} ( {pos}_{i} \text{\textbar} c ) + {β}_{3} {P}_{BG} ( {w}_{i - 1} {w}_{i} \text{\textbar} c ) + \\ {β}_{4} {P}_{PBG} ( {pos}_{i - 1} {pos}_{i} \text{\textbar} c ) + {β}_{5} {P}_{TG} ( {w}_{i - 2} {w}_{i - 1} {w}_{i} \text{\textbar} c ) + \\ {β}_{6} {P}_{PTG} ( {pos}_{i - 2} {pos}_{i - 1} {pos}_{i} \text{\textbar} c ) + {β}_{7} {P}_{MBG} ( {w}_{i} \text{\textbar} {w}_{i - 1} c ) + \\ {β}_{8} {P}_{MPBG} ( {pos}_{i} \text{\textbar} {pos}_{i - 1} c ) + {β}_{9} {P}_{MTG} ( {w}_{i} \text{\textbar} {w}_{i - 2} {w}_{i - 1} c ) + \\ {β}_{10} {P}_{MPTG} ( {pos}_{i} \text{\textbar} {pos}_{i - 2} {pos}_{i - 1} c )\end{matrix} \qquad ( 13 )$$

The classification system uses a linear regression model to learn the coefficients automatically. Regression is used to determine the relationships between two random variables x=(x₁, x₂, . . . , xₚ) and y. Linear regression attempts to explain the relationship of x and y with a straight line fit to the data. The linear regression model is represented by the following:

$$y = {b}_{0} + {\sum }_{j = 1}^{p} {b}_{j} {x}_{j} + e \qquad ( 14 )$$

where the “residual” e represents a random variable with mean zero and the coefficients bⱼ(0≦j≦p) are determined by the condition that the sum of the square residuals is as small as possible. The independent variable x is the probability that a single term belongs to a classification under the 10 models, x=(P_{BNB}, P_{BG}, P_{TG}, P_{MBG}, P_{MTG}, P_{PNB}, P_{PBG}, P_{PTG}, P_{MPBG}, P_{MPTG}), and the dependent variable y is the probability between 0 and 1, which indicates whether the word belongs to a classification or not.

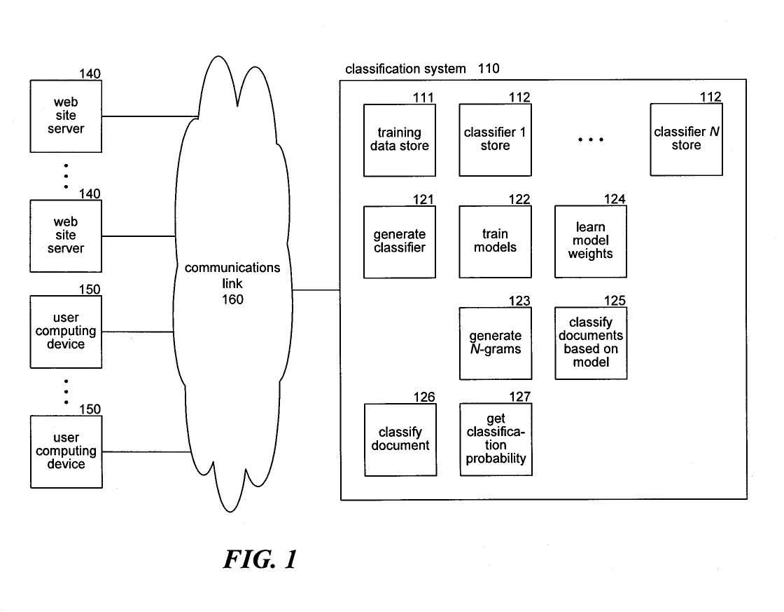

FIG. 1 is a block diagram that illustrates components of a classification system in one embodiment. The classification system 110 is connected to web site servers 140 and user computing devices 150 via communications link 160. The classification system includes a training data store 111 and classifier stores 112. The training data store contains the training documents that may have been collected by crawling the web site servers for web logs and extracting sentences of the web logs as training documents. The classification system may maintain a classifier store for each classification. If the classification system is used to classify a target document as subjective or objective, the classification system may have a classifier store for the subjective classification and a classifier store for the objective classification. The classification system may have only one classifier store if it classifies documents as being in a classification or not in the classification. Each classifier store contains the probabilities for the various n-grams for each of the models. In addition, a classifier store contains the coefficients or weights for each of the models that is used to weight the probabilities of the models when calculating a combined probability.

The classification system also includes a generate classifier component 121, a train models component 122, a generate n-grams component 123, a learn model weights component 124, and a classify documents based on model component 125. The generate classifier component collects and labels the training documents, trains the models, and then learns the weights for the models. The generate classifier component invokes the train models component to train the models, which invokes the generate n-grams component to generate n-grams. The generate classifier component invokes the learn model weights component to learn the model weights, and the learn model weights component invokes the classify documents based on model component to determine the classification of training documents.

The classification system also includes a classify document component 126 and a get classification probability component 127. The classify document component generates the n-grams for the models and then invokes the get classification probability component for each classifier to determine the probability that a target document is within that classification. The component then selects the classification with the highest probability.

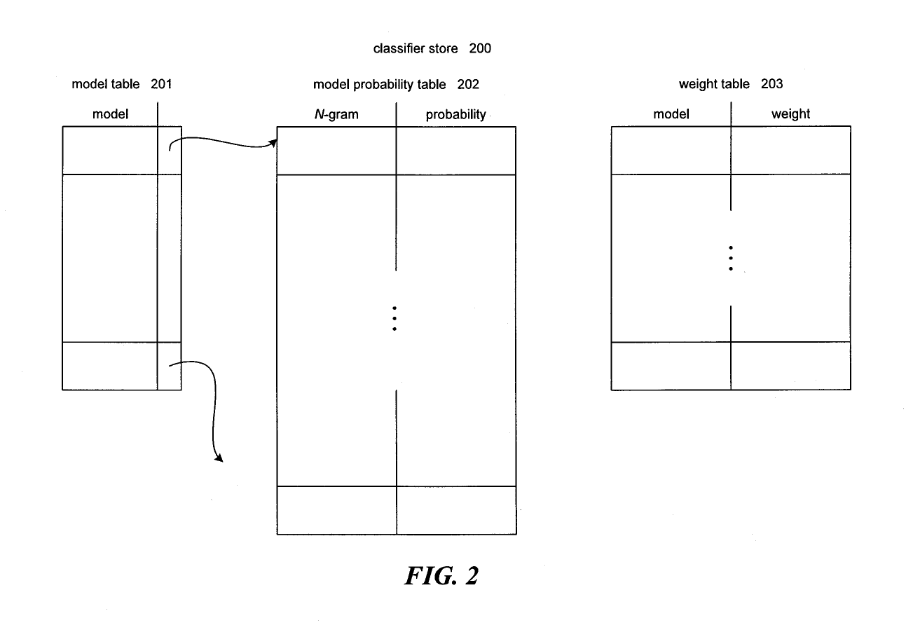

FIG. 2 is a block diagram that illustrates a logical data structure of a classifier store in one embodiment. A classifier store 200 includes a model table 201, a probability table 202, and a weight table 203. The model table contains an entry for each of the models with a reference to a model probability table. A model probability table contains an entry for each n-gram identified during training along with the associated probability. The weight table contains an entry for each of the models. Each entry identifies the model and contains the corresponding weight learned during the linear regression.

The computing device on which the classification system is implemented may include a central processing unit, memory, input devices (e.g., keyboard and pointing devices), output devices (e.g., display devices), and storage devices (e.g., disk drives). The memory and storage devices are computer-readable media that may be encoded with computer-executable instructions that implement the system, which means a computer-readable medium that contains the instructions. In addition, the instructions, data structures, and message structures may be stored or transmitted via a data transmission medium, such as a signal on a communications link. Various communications links may be used, such as the Internet, a local area network, a wide area network, a point-to-point dial-up connection, a cell phone network, and so on.

Embodiments of the classification system may be implemented in or used in conjunction with various operating environments that include personal computers, server computers, hand-held or laptop devices, multiprocessor systems, microprocessor-based systems, programmable consumer electronics, digital cameras, network PCs, minicomputers, mainframe computers, cell phones, personal digital assistants, smart phones, personal computers, programmable consumer electronics, distributed computing environments that include any of the above systems or devices, and so on.

The classification system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments. For example, a separate computing system may crawl the web to collect the training data.

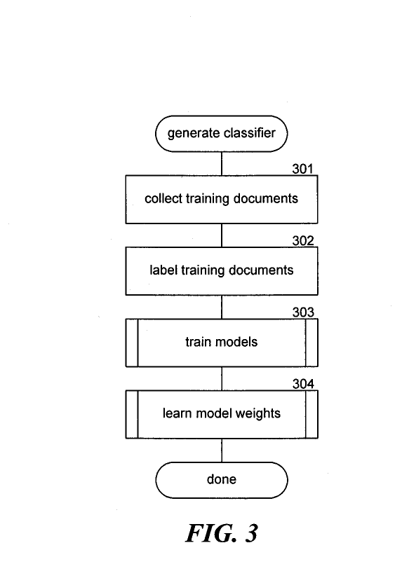

FIG. 3 is a flow diagram that illustrates the processing of the generate classifier component of the classification system in one embodiment. The component collects and labels training data, trains the models, and learns the model weights. In block 301, the component collects the training documents by crawling various web site servers and extracting content from web logs or other content sources. The component may store the training documents in the training data store. Alternatively, the training documents may have been collected previously and stored in the training data store. In block 302, the component labels the training documents, for example, by asking a user to designate each document as being subjective or objective. In block 303, the component invokes the train models component to train the models based on the training documents. In block 304, the component invokes the learn model weights component to learn the model weights for the models. The component then completes. The generate classifier component may be invoked to generate a classifier for the subjective classification and invoked separately to generate a classifier for the objective classification. The separate invocation might not need to re-collect the training data.

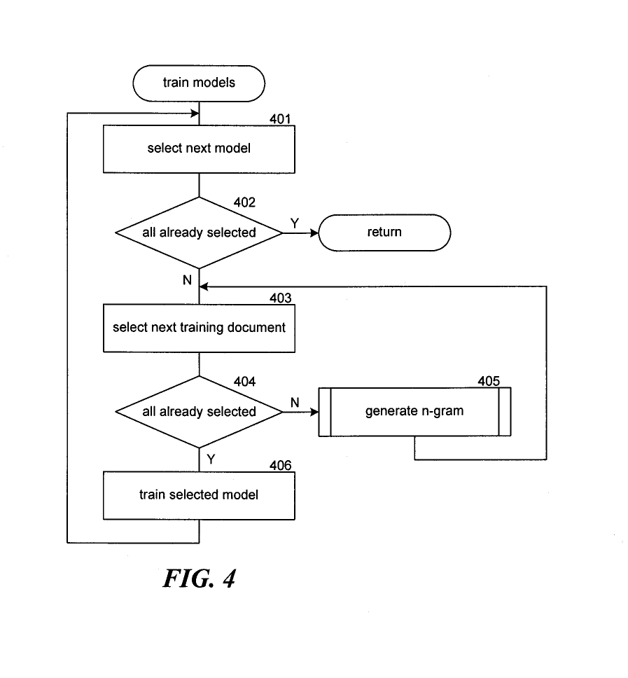

FIG. 4 is a flow diagram that illustrates the processing of the train models component of the classification system in one embodiment. The component generates the n-grams for each model and trains the model using the n-grams and labels. In block 401, the component selects the next model. In decision block 402, if all the models have already been selected, then the component returns, else the component continues at block 403. In block 403, the component selects the next training document. In decision block 404, if all the training documents have already been selected for the selected model, then the component continues at block 406, else the component continues at block 405. In block 405, the component invokes the generate n-grams component to generate the n-grams for the selected training document and the selected model. The component then loops to block 403 to select the next training document. In block 406, the component trains the selected model by calculating the probabilities for the various n-grams of the selected model. The component stores the probabilities in a classifier store. The component then loops to block 401 to select the next model.

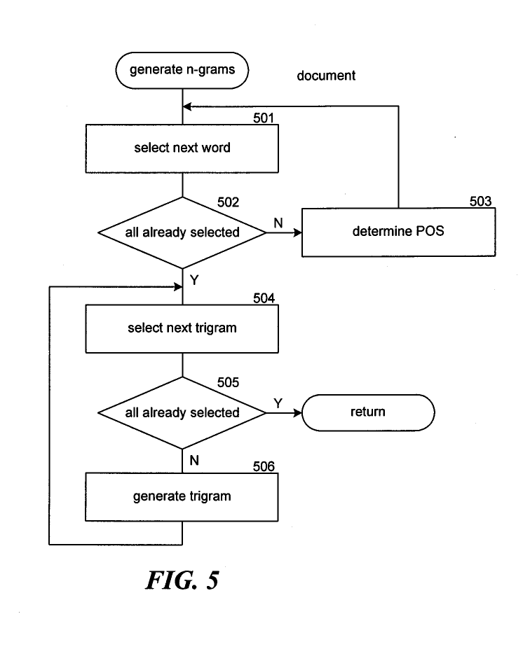

FIG. 5 is a flow diagram that illustrates the processing of the generate n-grams component of the classification system in one embodiment. The component is passed a document and generates the n-grams for the document for a particular model. In this example, the component generates the n-grams for the part-of-speech trigram model. The classification system may have a similar component for the other models. In blocks 501-503, the component loops determining the part of speech for each word of the document. In block 501, the component selects the next word of the document. In decision block 502, if all the words have already been selected, then the component continues at block 504, else the component continues at block 503. In block 503, the component determines the part of speech of the selected word. The component may use various well-known natural language processing techniques to identify the part of speech of the word. The component then loops to block 501 to select the next word. In blocks 504-506, the component loops selecting each trigram of the document. In block 504, the component selects the next trigram. In decision block 505, if all the trigrams have already been selected, then the component returns the trigrams, else the component continues at block 506. In block 506, the component generates the trigram for the selected trigram and stores the trigram along with accumulated counts needed to calculate the probabilities and then loops to block 504 to select the next trigram.

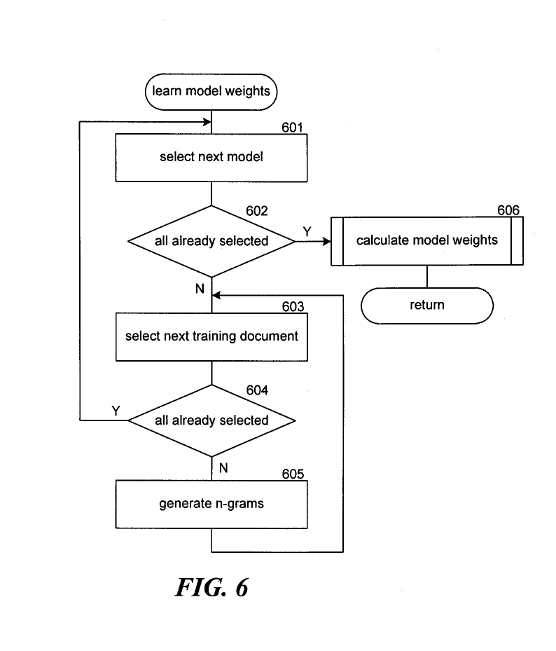

FIG. 6 is a flow diagram that illustrates the processing of the learn model weights component of the classification system in one embodiment. The component applies a linear regression technique to calculate the weight for the models that attempts to minimize an error between labels of training data and the classifications based on the weights. In block 601, the component selects the next model. In decision block 602, if all the models have already been selected, then the component continues at block 606, else the component continues at block 603. In blocks 603-605, the component loops generating n-grams for the training data used to learn the model weights. In block 603, the component selects the next training document. In decision block 604, if all the training documents have already been selected, then the component loops to block 601 to select the next model, else the component continues at block 605. In block 605, the component invokes the generate n-grams component to generate the n-grams for the selected training document and then loops to block 603 to select the next training document. In block 606, the component invokes a calculate model weights component to calculate the model weights using linear regression based on labels for the training documents and n-grams.

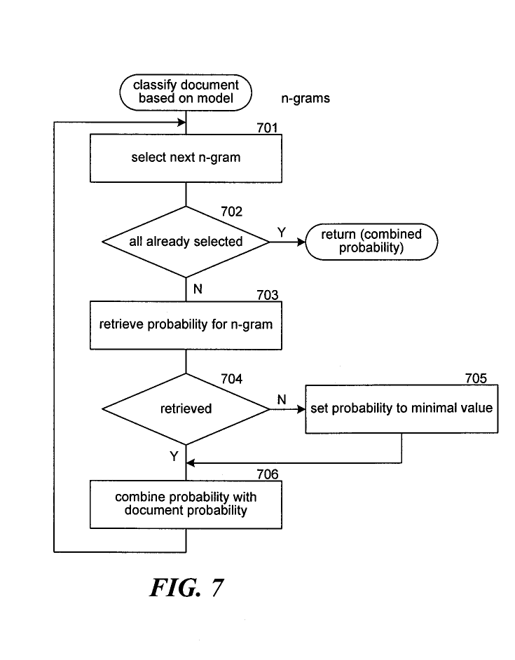

FIG. 7 is a flow diagram that illustrates the processing of the classify documents based on model component of the classification system in one embodiment. The component generates a combined probability for a document that the document is in the classification of the model. The component is passed the n-grams of the document. In block 701, the component selects the next n-gram of the document. In decision block 702, if all the n-grams have already been selected, then the component returns the combined probability, else the component continues at block 703. In block 703, the component retrieves a probability for the n-gram from the classifier store. In decision block 704, if the n-gram was not found in the classifier store, then the component continues at block 705, else the component continues at block 706. In block 705, the component sets the probability to a minimal value. In block 706, the component combines the probability with an accumulated combined probability for the document and then loops to block 701 to select the next n-gram.

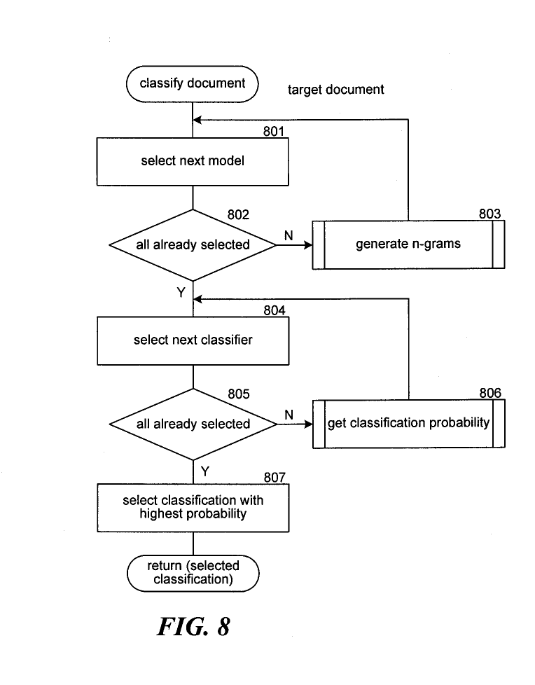

FIG. 8 is a flow diagram that illustrates the processing of the classify document component of the classification system in one embodiment. The component is passed a target document, generates the n-grams for the models, generates a probability that the document is in each of the classifications, and then selects the classification with the highest probability. In block 801, the component selects the next model. In decision block 802, if all the models have already been selected, then the component continues at block 804, else the component continues at block 803. In block 803, the component invokes the generate n-grams component to generate the n-grams for the target document and the selected model. The component then loops to block 801 to select the next model. In block 804, the component selects the next classifier. In decision block 805, if all the classifiers have already been selected, then the component continues at block 807, else the component continues at block 806. In block 806, the component invokes the get classification probability component to get the classification probability for the selected classifier and then loops to block 804 to select the next classifier. In block 807, the component selects the classification with the highest probability and indicates that as the classification for the target document.

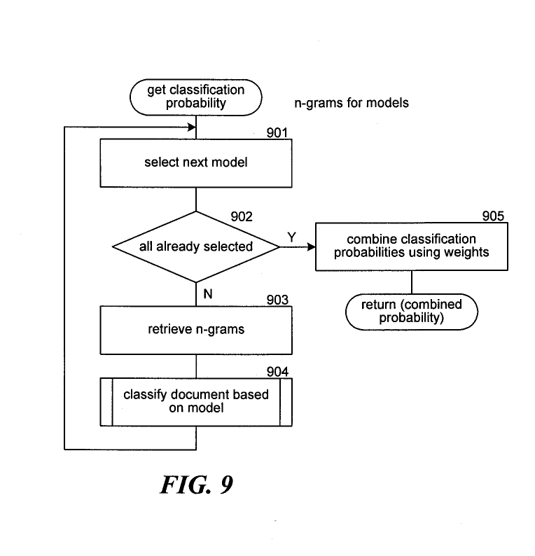

FIG. 9 is a flow diagram that illustrates the processing of the get classification probability component of the classification system in one embodiment. The component loops selecting models of the classifier, generating a probability based on the model, and then combining the probabilities. In block 901, the component selects the next model. In decision block 902, if all the models have already been selected, then the component continues at block 905, else the component continues at block 903. In block 903, the component retrieves the n-grams for the target document for the selected model. In block 904, the component invokes the classify documents based on model component to generate a probability for the target document for the selected model. The component then loops to block 901 to select the next model. In block 905, the component combines the classification probabilities using the weights of the models and then returns the combined probability.

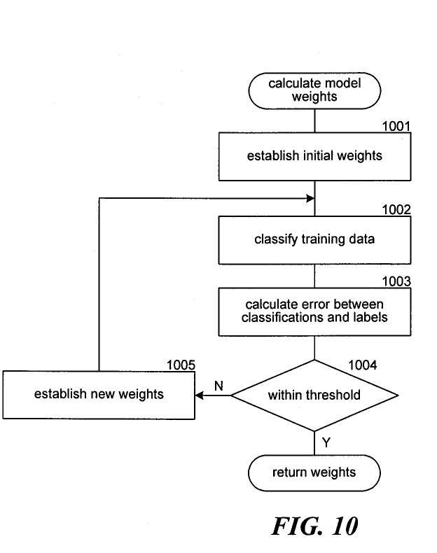

FIG. 10 is a flow diagram that illustrates the processing of the calculate model weights component of the classification system in one embodiment. The component loops adjusting the weights until the error between the classifications and labels of the training data is within a threshold. In block 1001, the component establishes the initial weights (e.g., all equal and add to one). In block 1002, the component determines the classification of each training document for each model. In block 1003, the component calculates the error between the classifications and the labels. In decision block 1004, if the error is within a threshold, then the component returns the weights, else the component continues at block 1005. In block 1005, the component establishes new weights in an attempt to minimize the error and loops to block 1002 to perform another iteration.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. The classification system may be used to classify documents based on any type of classification such as interrogative sentences or imperative sentences, questions and answers in a discussion thread, and so on. The classification system may be trained with documents from one domain and used to classify documents in a different domain. The classification system may be used in conjunction with other supervised machine learning techniques such as support vector machines, neural networks, and so on. Accordingly, the invention is not limited except as by the appended claims.

I/We claim:

1. A method in a computing device for classifying documents having terms, the method comprising:
for training documents,
identifying parts of speech of the terms of the training documents;
labeling the training documents;
generating n-grams based on parts of speech of the terms of the training documents; and
generating n-grams based on terms of the training documents;
training a part-of-speech model to classify documents based on the part-of-speech n-grams of the training documents;
training a term model to classify documents based on the term n-grams of the training documents; and
classifying a target document using the part-of-speech model and the term model.

2. The method of claim 1 wherein the documents are classified as being subjective or objective.

3. The method of claim 1 wherein each document contains only one sentence.

4. The method of claim 1 including learning weights for the part-of-speech model and the term model and wherein the classifying of the target document factors in the weights of the models.

5. The method of claim 4 wherein the weights are learned using a linear regression technique.

6. The method of claim 1 wherein the models are Bayesian-based.

7. The method of claim 6 wherein multiple part-of-speech models are trained including a model based on Markov part-of-speech n-grams.

8. The method of claim 6 wherein multiple term models are trained including a model based on n-grams greater than one.

9. The method of claim 1 wherein the classifying includes generating n-grams based on the parts of speech of the target document and applying the part-of-speech model to the n-grams to generate a part-of-speech model probability, generating n-grams based on terms of the target document and applying the term model to the n-grams to generate a term model probability; and combining the part-of-speech model probability and the term model probability to generate an overall probability.

10. The method of claim 1 wherein a part-of-speech model and a term model are trained for each of a plurality of classifications and the classifying includes using the models to generate a probability for each classification and selecting the classification of the target document based on the generated probabilities.

11. The method of claim 1 wherein the target document includes a term not in the documents of the training documents.

12. The method of claim 1 wherein the training documents are in a domain different from the domain of the target document.

13. A computer-readable medium encoded with instructions for controlling a computing device to generate a classifier for documents having terms, by a method comprising:
for each training document,
identifying parts of speech of the terms of the training document;
labeling the training document with a classification;
generating n-grams based on the parts of speech of the training document; and
generating n-grams based on terms of the training document;
training multiple part-of-speech models to classify documents based on the part-of-speech n-grams of the training documents;
training multiple term models to classify documents based on the term n-grams of the training documents; and
learning weights for the multiple part-of-speech models and the multiple term models
wherein the part-of-speech models, the term models, and the weights are for classifying target documents.

14. The computer-readable medium of claim 13 wherein the documents are classified as being subjective or objective.

15. The computer-readable medium of claim 13 wherein a target document includes a term not in the training documents.

16. The computer-readable medium of claim 13 wherein the weights are learned using a linear regression technique.

17. The computer-readable medium of claim 13 wherein a part-of-speech model is based on a Markov part-of-speech n-gram.

18. A computing device for classifying target documents, the target documents having terms that are not included in training documents used to train a classifier, comprising:
a document store having for each training document terms of the training document, parts of speech of the terms of the training document, and a classification of the training document;
a component that trains a part-of-speech model to classify documents based on part-of-speech n-grams of the training documents;
a component that trains a term model to classify documents based on the term n-grams of the training documents; and
a component that classifies a target document using the part-of-speech model and the term model.

19. The computing device of claim 18 wherein a separate part-of-speech model and a separate term model are trained for each classification.

20. The computing device of claim 18 wherein the training documents and the target documents are from different domains.
